(19) United States
(12) Patent Application Publication
(10) Pub. No.: US 2025/0086905 A1
(43) Pub. Date: Mar. 13, 2025

(54) INTERACTIVE VIRTUAL OBJECT PLACEMENT WITH CONSISTENT PHYSICAL REALISM

(71) Applicant: REMBRAND, INC., Los Altos, CA (US)

(72) Inventors: Abdelrahman Samir Abdelrahman MOHAMED, Redmond, WA (US); Sameh KHAMIS, Alameda, CA (US); Ahmed Aly Saad AHMED, Bothell, WA (US); David Abraham WIENER, Redwood City, CA (US)

(21) Appl. No.: 18/882,295

(22) Filed: Sep. 11, 2024

Related U.S. Application Data
(60) Provisional application No. 63/582,469, filed on Sep. 13, 2023.

(51) Int. Cl. G06T 19/00

(52) U.S. Cl. CPC G06T 19/006

(57) ABSTRACT

The present invention sets forth a technique for performing virtual object placement in a video sequence. The technique includes identifying a planar surface depicted in an input video sequence and selecting a virtual object included in an object library. The technique also includes generating, for a combination of the planar surface and the virtual object, a suitability metric associated with the combination, wherein the suitability metric is based at least on a semantic compatibility between the virtual object and the planar surface. The technique further includes generating, via one or more machine learning models, a modified video sequence based on the suitability metric, where the modified video sequence depicts the virtual object placed on the planar surface.

### CROSS-REFERENCE TO RELATED APPLICATIONS

This application claims the priority benefit of United States provisional patent application titled, “INTERACTIVE VIRTUAL OBJECT PLACEMENT WITH CONSISTENT PHYSICAL REALISM,” filed Sep. 13, 2023, and having Ser. No. 63/582,469. The subject matter of this related application is hereby incorporated herein by reference.

### BACKGROUND

### Field of the Various Embodiments

Embodiments of the present disclosure relate generally to visual effects, augmented reality, computer vision and, more specifically, to techniques for performing interactive virtual object placement with consistent physical realism.

### DESCRIPTION OF THE RELATED ART

In the field of visual effects (VFX), virtual object placement refers to the insertion of one or more virtual objects into an existing video representation of a real-world scene, such as a recorded video sequence or a live video stream. Video creators may place virtual objects in a recorded video sequence, e.g., a movie or television program, for creative purposes or as part of an advertising or product placement strategy. Augmented reality (AR) systems may insert one or more virtual objects into a live video stream alongside real-world objects. For example, an augmented reality system may allow a user to insert virtual representations of home furnishings, decorations, or other objects into a live video stream of the user's living room to simulate an arrangement of objects without the need to procure and physically place the objects within the user's home.

Existing techniques for virtual object placement may rely on extensive manual manipulation, such as rotoscoping, where a creator manually traces around a depiction of an object in a still image or video sequence to create a matte, which is then inserted into a different still image or video sequence. Manual manipulation is time-consuming and requires significant skill. Further, manual manipulation methods may not account for lighting, atmospheric, or other environmental differences between scenes, resulting in an artificial or otherwise unnatural appearance for objects that have been extracted from one scene and placed into another scene.

Other existing techniques may automate portions of the object placement process, such as simple object extraction and placement. Similar to manual methods, these automated or semi-automated techniques may not address the environmental conditions into which the virtual object is to be placed, and may yield similarly unnatural results. Further, these techniques may provide few or no opportunities for user interaction during virtual object placement, and may require a trial-and-error approach involving numerous iterations with different configurations of user settings for each iteration, followed by a human evaluation of each iteration's results.

As the foregoing illustrates, what is needed in the art are more effective techniques for performing automated physical variance detection.

### SUMMARY

One embodiment of the present invention includes a computer-implemented method for performing virtual object placement in a video sequence. The computer-implemented method comprises identifying a planar surface depicted in an input video sequence and selecting a virtual object included in an object library. The method also includes generating, for a combination of the planar surface and the virtual object, a suitability metric associated with the combination, wherein the suitability metric is based at least on a semantic compatibility between the virtual object and the planar surface. The method further includes generating, via one or more machine learning models, a modified video sequence based on the suitability metric, wherein the modified video sequence depicts the virtual object placed on the planar surface.

One technical advantage of the disclosed techniques relative to the prior art is that the disclosed techniques provide an automated, end-to-end approach to virtual object placement. The disclosed techniques automatically identify placement locations for a virtual object in a video sequence, where the placement locations are both physically suitable for the virtual object and contextually appropriate based on the semantic attributes of the scene. The disclosed techniques may also automatically adjust the appearance of the virtual object to match the environmental conditions of the destination scene. The disclosed techniques further provide both automatic and manual adjustment of user settings during virtual object placement, providing immediate feedback to the user and obviating the need for repetitive manual adjustment and evaluation. These technical advantages provide one or more improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a representation of the data flow between various components of the present invention, according to some embodiments.

FIG. 3 represents a timeline including various components of the present invention, including input and output data associated with the various components, according to some embodiments.

FIG. 4 is a more detailed illustration of the video engine of FIG. 1, according to some embodiments.

FIG. 5 is a flow diagram of method steps for generating video metadata, according to some embodiments.

FIG. 6 is a more detailed illustration of the environment engine of FIG. 1, according to some embodiments.

FIG. 7 is a flow diagram of method steps for generating environment metadata, according to some embodiments.

FIG. 8 is a more detailed illustration of the placement engine of FIG. 1, according to some embodiments.

FIG. 9 is a flow diagram of method steps for inserting one or more virtual objects into a scene, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

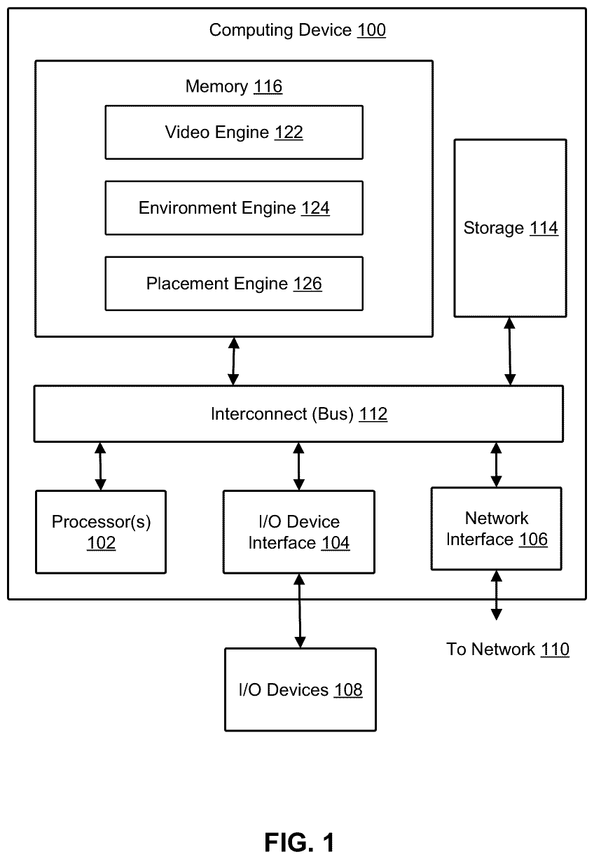

FIG. 1 illustrates a computing device 100 configured to implement one or more aspects of various embodiments. In one embodiment, computing device 100 includes a desktop computer, a laptop computer, a smart phone, a personal digital assistant (PDA), tablet computer, or any other type of computing device configured to receive input, process data, and optionally display images, and is suitable for practicing one or more embodiments. Computing device 100 is configured to run a video engine 122, an environment engine 124, and a placement engine 126 that reside in a memory 116.

It is noted that the computing device described herein is illustrative and that any other technically feasible configurations fall within the scope of the present disclosure. For example, multiple instances of video engine 122, environment engine 124, and/or placement engine 126 could execute on a set of nodes in a distributed and/or cloud computing system to implement the functionality of computing device 100. In another example, video engine 122, environment engine 124, and/or placement engine 126 could execute on various sets of hardware, types of devices, or environments to adapt video engine 122, environment engine 124, and/or placement engine 126 to different use cases or applications. In a third example, video engine 122, environment engine 124, and/or placement engine 126 could execute on different computing devices and/or different sets of computing devices.

In one embodiment, computing device 100 includes, without limitation, an interconnect (bus) 112 that connects one or more processors 102, an input/output (I/O) device interface 104 coupled to one or more input/output (I/O) devices 108, memory 116, a storage 114, and a network interface 106. Processor(s) 102 may be any suitable processor implemented as a central processing unit (CPU), a graphics processing unit (GPU), an application-specific integrated circuit (ASIC), a field programmable gate array (FPGA), an artificial intelligence (AI) accelerator, any other type of processing unit, or a combination of different processing units, such as a CPU configured to operate in conjunction with a GPU. In general, processor(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing instance executing within a computing cloud.

I/O devices 108 include devices capable of providing input, such as a keyboard, a mouse, a touch-sensitive screen, a microphone, and so forth, as well as devices capable of providing output, such as a display device or speaker. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 is any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Video engine 122, environment engine 124, and/or placement engine 126 may be stored in storage 114 and loaded into memory 116 when executed.

Memory 116 includes a random-access memory (RAM) module, a flash memory unit, or any other type of memory unit or combination thereof. Processor(s) 102, I/O device interface 104, and network interface 106 are configured to read data from and write data to memory 116. Memory 116 includes various software programs that can be executed by processor(s) 102 and application data associated with said software programs, including video engine 122, environment engine 124, and/or placement engine 126.

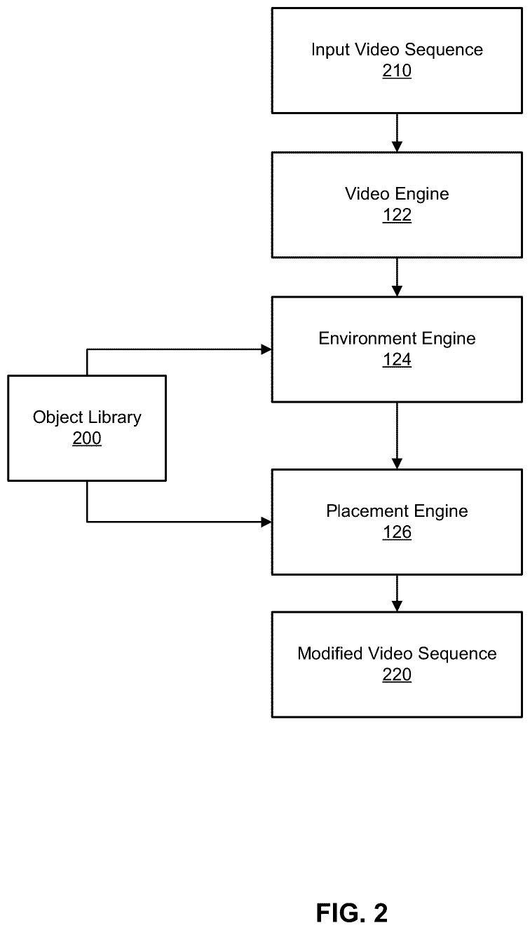

FIG. 2 is a representation of a data flow between various components of the present invention, according to some embodiments. As shown, the various components include, but are not limited to, video engine 122, environment engine 124, and placement engine 126. The present invention analyzes input video sequence 210 and generates modified video sequence 220, where modified video sequence 220 is augmented with one or more virtual objects included in object library 200.

In various embodiments, input video sequence 210 may include pre-recorded video content, such as a movie, television episode, or commercial advertisement. Input video sequence 210 may also include a real-time or near real-time video stream, such as a videoconferencing application, live video broadcasting application, or an augmented reality application. Input video sequence 210 includes multiple frames, where each frame includes a rectangular arrangement of pixels.

Video engine 122 analyzes input video sequence 210 and generates video metadata associated with input video sequence 210. Video engine 122 detects one or more shots and scenes included in input video sequence 210, where a shot is a sequential series of consecutive frames captured from a single fixed or moving camera viewpoint and a scene includes one or more shots portraying the same visual environment, room, or locale. Video engine 122 may also identify clusters of similar shots and clusters of similar scenes included in input video sequence 210.

For each shot included in input video sequence 210, video engine 122 may identify dynamic content included in the shot. For example, video engine 122 may identify moving entities such as doors, people, animals, or vehicles. For each frame included in a shot, video engine 122 may generate a two-dimensional (2D) mask associated with each moving entity that describes the pixels in the frame that are occupied by the entity.

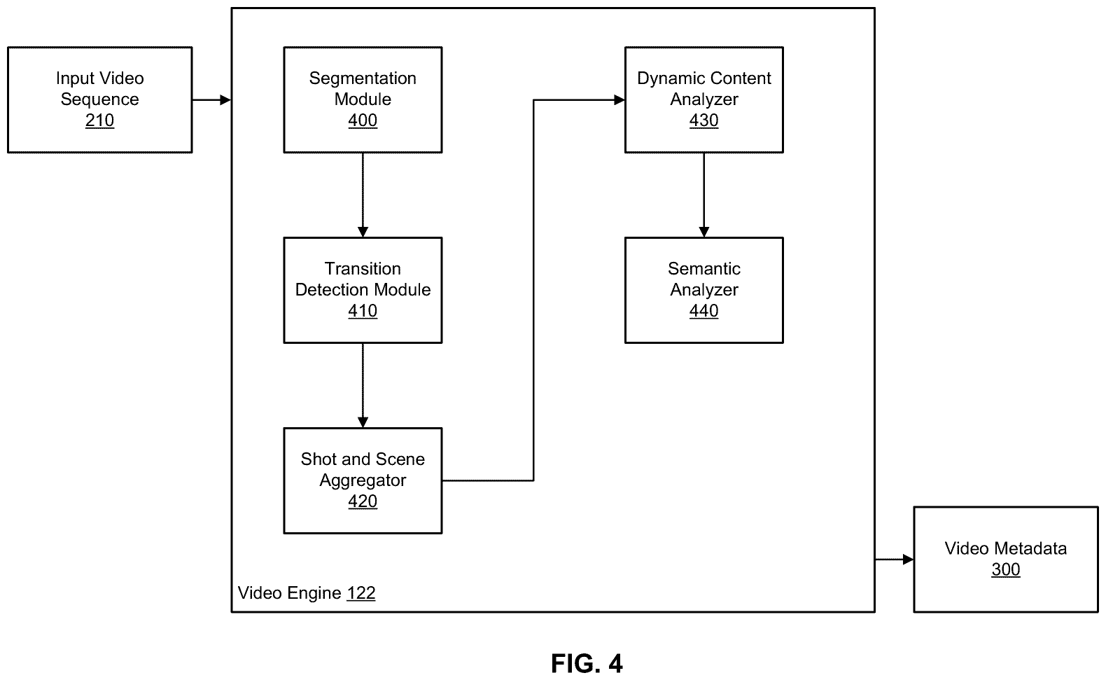

Video engine 122 may also analyze the video or audio content included in input video sequence 210 and perform video or audio semantic analysis on the video or audio content. Based on the video or audio semantic analysis, video engine 122 generates semantic metadata associated with the shot, including a list of one or more objects included in the shot, a contextual description of the shot, or a semantic description of an environment or locale depicted in the shot. Video engine 122 generates video metadata associated with input video sequence 210 based on the identified and clustered shots and scenes, the identified dynamic content, and the video or audio semantic analysis. Video engine 122 is discussed in more detail in the description of FIG. 4 below.

Environment engine 124 analyzes shots and scenes included in input video sequence 210, estimates intrinsic and extrinsic parameters for one or more cameras associated with input video sequence 210, and analyzes objects and environments depicted in input video sequence 210. Environment engine 124 further calculates one or more suitability rankings based on one or more virtual objects included in object library 200 and one or more environmental surfaces identified in input video sequence 210.

For a shot included in input video sequence 210, environment engine 124 estimates intrinsic and extrinsic camera parameters associated with the shot. Intrinsic camera parameters may include a focal length associated with the camera, distortion data associated with the camera, or a principal point associated with the camera. Extrinsic camera parameters may include the camera's rotation, orientation, or movement during the video capture of the shot. The environment engine also calculates a comprehensive track of the camera's position during the shot, whether the camera is stationary or in motion.

For each frame included in a shot, environment engine 124 estimates a relative depth value for each pixel included in the frame. The relative depth values indicate whether a pixel is closer to or farther away from the camera compared to a different pixel. Based on the relative depth values, the disclosed techniques may determine whether an object to be inserted into a scene will be occluded (blocked) by one or more different objects included in the scene.

Environment engine 124 may also detect one or more planar surfaces included in a frame of input video sequence 210. Planar surfaces may include horizontal or vertical surfaces, such as a wall or the top surface of a desk. For each detected planar surface, environment engine 124 generates a polygon that defines the boundary of the planar surface and the pixels included in the planar surface. For each pixel included in a planar surface, environment engine 124 calculates a normal vector describing the orientation of the pixel.

Environment engine 124 may also identify one or more objects included in a frame and generate a three-dimensional (3D) bounding box associated with each object. Environment engine estimates physical dimensions for each identified object based on the 3D bounding boxes and the relative depth values for pixels included in the object.

Environment engine 124 further analyzes material properties associated with each identified planar surface in a frame, including roughness, albedo, and metallic or reflective properties. Environment engine 124 may analyze the lighting conditions depicted in a frame of input video sequence 210 and generate two-dimensional (2D) spatially varying light maps and 3D light maps that incorporate the relative depth values for pixels included in the frame. Environment engine 124 determines direct and indirect light sources illuminating the frame based on the generated light maps.

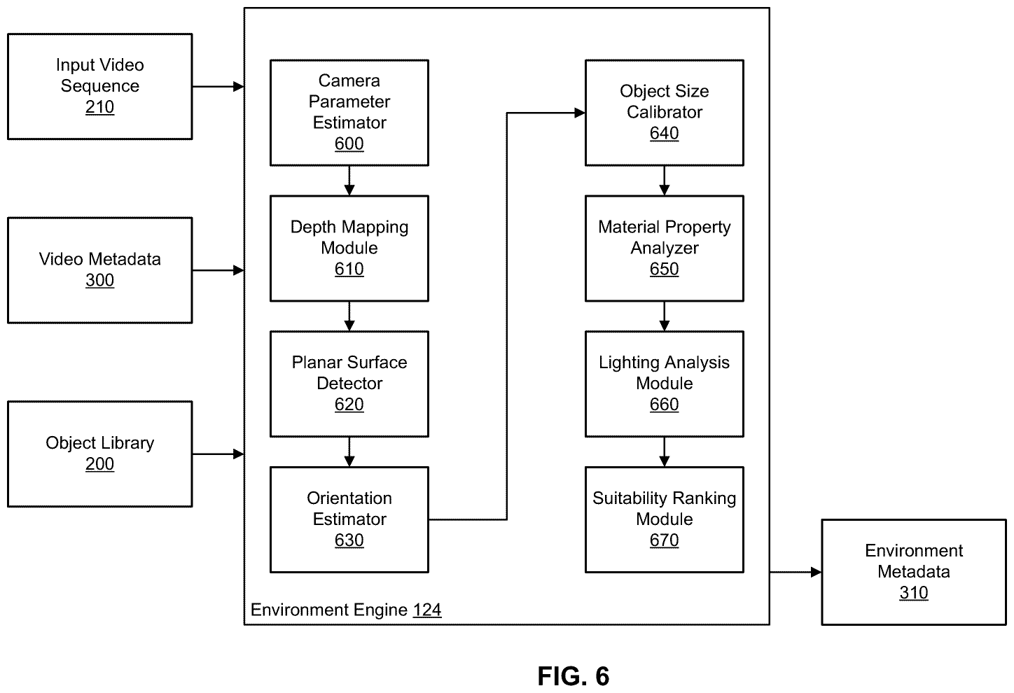

Environment engine 124 generates suitability rankings associated with combinations of virtual objects included in object library 200 and planar surfaces identified in a frame of input video sequence 210. Object library 200 may include depictions of one or more virtual objects and metadata associated with the one or more virtual objects. Metadata associated with a virtual object may include a name of the object, a textual description of the object, physical dimensions describing the object, or semantic terms associated with the object. For each combination of a virtual object and a planar surface, environment engine 124 generates a suitability ranking based on the size of the virtual object, whether or not the virtual object will be occluded by one or more other objects when placed on the planar surface, or whether the virtual object will be in focus. Environment engine 124 may also calculate a contextual suitability associated with a virtual object/planar surface combination based on semantic features associated with the virtual object and semantic features associated with a scene. For example, a virtual object that includes a framed photograph may be more contextually appropriate for placement on a desk or a wall than for placement on a bathroom sink. Environment engine 124 stores the calculated depth, surface, object, lighting, and suitability data for each scene as environment metadata. Environment engine 124 is discussed in greater detail in the description of FIG. 6 below.

Placement engine 126 augments input video sequence 210 with one or more virtual objects included in object library 200 and generates modified video sequence 220. Placement engine 126 includes an interactive user interface that allows a user to select one or more virtual objects from object library 200 and adjust the placement and appearance of the one or more virtual objects within a scene included in input video sequence 210. Placement engine 126 includes one or more machine learning models, such as rendering generators, diffusion generators, and discriminators. Placement engine 126 may automatically modify one or more parameters associated with the machine learning models based on a calculated adversarial loss. Placement engine 126 may present the one or more parameters to the user for further adjustment via virtual knobs, sliders, or other user interface controls. The automatic modification of the one or more machine learning model parameters provides realistic-appearing placement of virtual objects into a scene while still enabling manual user adjustment.

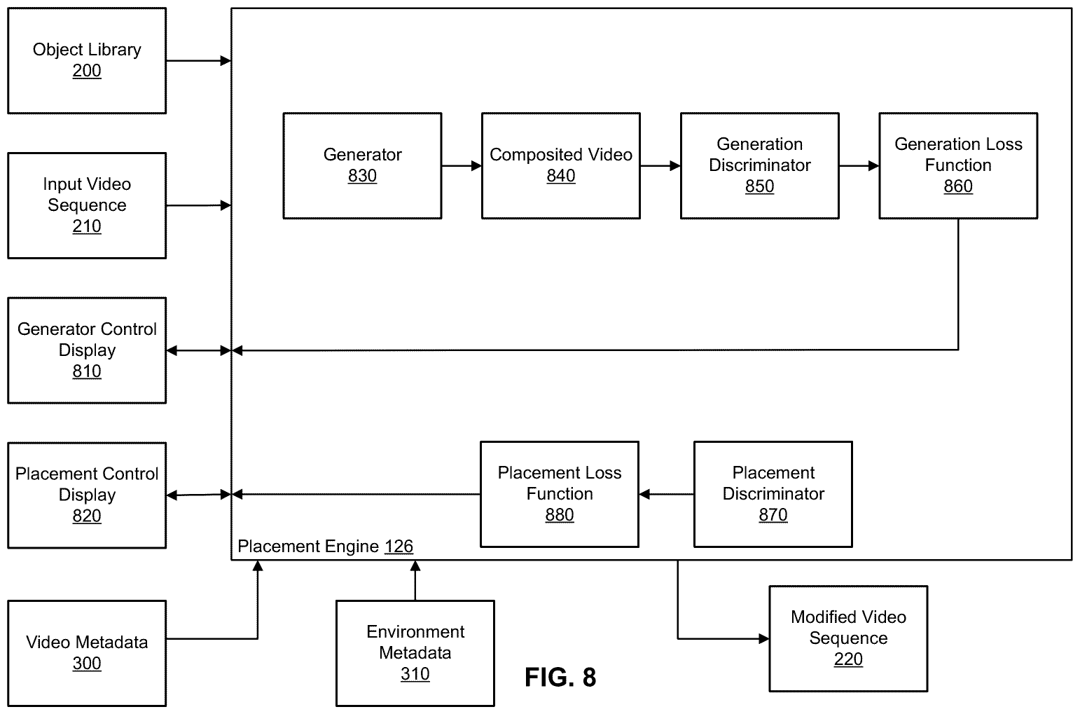

Placement engine 126 may further fine-tune one or more machine learning model parameters based on a user's historical preferences. Placement engine 126 may include a trained discriminator that distinguishes between augmented videos crafted by a specific user and augmented videos generated by a random user. The trained discriminator may also distinguish between augmented videos crafted by a specific user and videos that do not include virtual augmentation. Placement engine 126 adjusts the one or more machine learning model parameters based on an adversarial loss generated by the trained discriminator. These parameter adjustments ensure alignment with the current user's preferences, inferred from their past interactions and placements in historical videos. Placement engine 126 generates modified video sequence 220 that includes all or a portion of input video sequence 210 as modified via user interaction to include one or more virtual objects included in object library 200. Placement engine 126 is discussed in more detail in the description of FIG. 8 below.

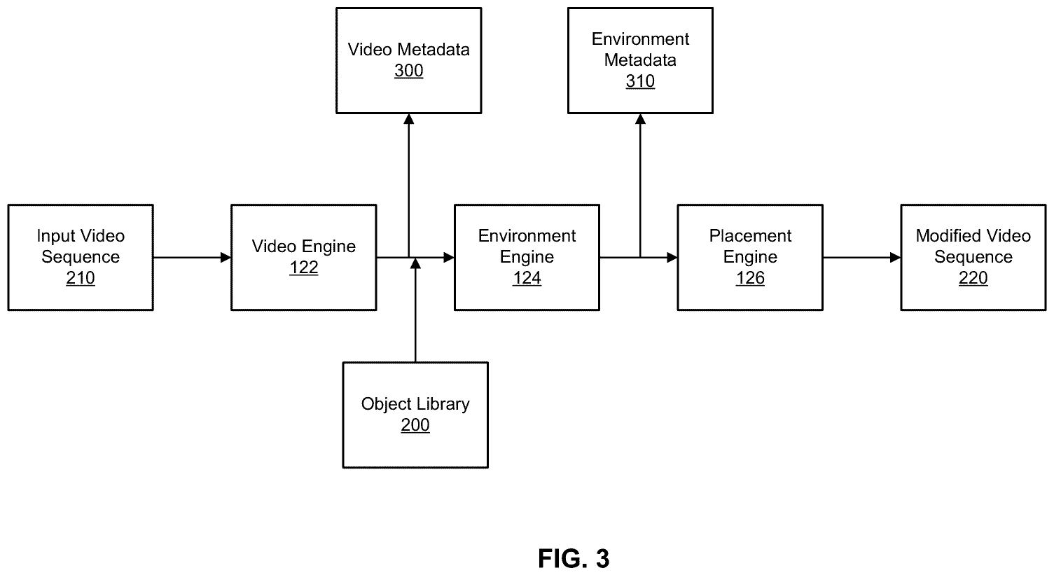

FIG. 3 represents a timeline including various components of the present invention, including input and output data associated with the various components, according to some embodiments. The output data includes, but is not limited to, video metadata 300, environment metadata 310, and modified video sequence 220.

Video engine 122 receives and analyzes input video sequence 210 to generate video metadata 300, including scene or shot clustering, dynamic content identification, and semantic information associated with input video sequence 210. Environment engine 124 analyzes one or more locales or environments included in input video sequence 210 and described in video metadata 300. Based on input video sequence 210, video metadata 300, and object library 200, environment engine 124 generates environment metadata 310, including estimated camera parameters, one or more depth maps, and analyses of the surfaces, objects, materials, or lighting conditions included in input video sequence 210. Placement engine 126 augments input video sequence 210 via the user-directed insertion of one or more virtual objects included in object library 200 into input video sequence 210. Placement engine 126 inserts the one or more virtual objects based on video metadata 300, environment metadata 310, user inputs, and one or more machine learning models. Placement engine 126 generates modified video sequence 220, where modified video sequence 220 includes all or a portion of input video sequence 210 as augmented with one or more virtual objects included in object library 200.

FIG. 4 is a more detailed illustration of video engine 122 of FIG. 1, according to some embodiments. Video engine 122 receives input video sequence 210 and generates video metadata 300. Video engine 122 includes, without limitation, segmentation module 400, transition detection module 410, shot and scene aggregator 420, dynamic content analyzer 430, and semantic analyzer 440.

Segmentation module 400 divides input video sequence 210 into multiple shots, where each shot includes a sequential series of consecutive frames captured from a single fixed or moving camera viewpoint. Temporally adjacent shots included in input video sequence 210 may be separated by a camera cut. Segmentation module 400 may detect a camera cut based on a change in camera viewpoint between consecutive frames in the input video sequence.

Transition detection module 410 identifies one or more scenes included in input video sequence 210, where each scene includes a visual depiction of a particular locale or environment. A scene may include one or more shots, and scenes may be non-contiguous, i.e., the same scene may appear in multiple non-consecutive portions of input video sequence 210. Transition detection module 410 may detect transitions from one scene to another scene based on the presence of common video transition effects such as wipes, fade-ins, and fade-outs. Transition detection module 410 may also detect a transition from one scene to another based on a threshold quantity of pixel-level changes between adjacent frames included in input video sequence 210.

Shot and scene aggregator 420 generates clusters of similar shots and similar scenes included in input video sequence 210. Within a portion of input video sequence 210, shot and scene aggregator 420 may cluster multiple shots captured from identical camera positions. Shot and scene aggregator 420 may further separate the clustered shots into those shots captured from a stationary camera and those shots captured from a moving camera. Shot and scene aggregator 420 also clusters shots included in input video sequence 210 into scenes, where multiple shots clustered into a scene each depict the same visual locale or environment. As discussed above, the same scene may appear in multiple non-contiguous portions of input video sequence 210.

Dynamic content analyzer 430 may identify moving objects included in a particular shot, such as doors, humans, animals, or vehicles. Via any suitable segmentation technique, dynamic content analyzer 430 determines changes in an object's position between two or more consecutive frames included in a shot. For each frame included in a shot, dynamic content analyzer 430 generates a 2D floating-point mask that delineates the pixels occupied by the moving object. The floating-point mask may capture detailed characteristics of an object's boundaries, including semi-transparent boundaries such as hair or feathers. Dynamic content analyzer 430 obviates the need for time-consuming manual rotoscoping, where a user must trace the outlines of an object frame-by-frame.

Semantic analyzer 440 generates one or more semantic features associated with input video sequence 210 via a machine learning model, such as a multimodal large language model (MLLM). For each shot included in input video sequence 210, the machine learning model of semantic analyzer 440 analyzes both the video and audio content included in the shot. Semantic analyzer 440 may generate semantic features that name or describe one or more objects depicted in a shot. Semantic analyzer 440 may also generate semantic features based on the audio content of the shot, such as dialog, music, or sound effects. These audio-based semantic features may provide contextual clues as to the location or mood of the shot, as well as to the actions or dialog included in a shot. As discussed below in the description of FIG. 6, environment engine 124 generates one or more suitability rankings based at least on the semantic features, where a suitability ranking may describe the contextual compatibility between a virtual object and a scene into which the virtual object is to be placed.

Video engine 122 generates video metadata 300 associated with input video sequence 210. Video metadata 300 includes lists of frames that comprise individual shots, as well as lists of shots that depict each of one or more scenes. For each frame included in input video sequence 210, video metadata 300 also includes floating-point masks delineating the boundaries of moving objects included in the frame. Video metadata 300 may further include objects identified in input video sequence 210 as well as semantic features describing the objects or audio content included in input video sequence 210. The operations of video engine 122 are non-destructive and do not require any modifications to input video sequence 210. In various embodiments, video metadata 300 may be stored as a separate sidecar file that is associated with input video sequence 210.

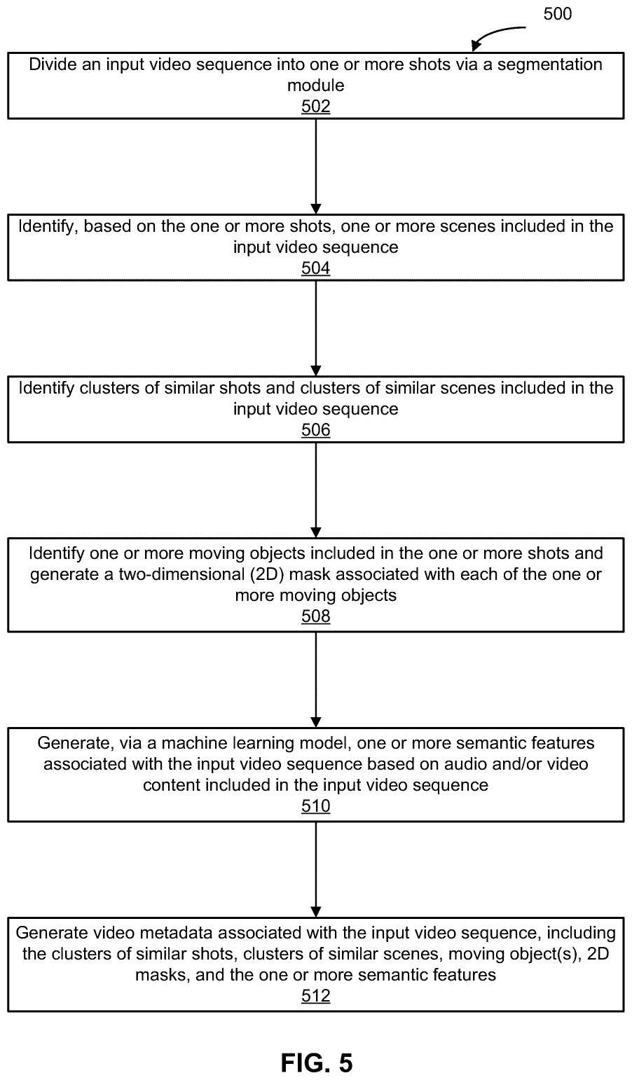

FIG. 5 is a flow diagram of method steps for generating video metadata, according to some embodiments. Although the method steps are described in conjunction with the systems of FIGS. 1 and 4, persons skilled in the art will understand that any system configured to perform the method steps in any order falls within the scope of the present disclosure.

As shown, in operation 502 of method 500, video engine 122 divides input video sequence 210 into one or more shots via segmentation module 400, where each shot includes a sequential series of consecutive frames captured from a single fixed or moving camera viewpoint. Temporally adjacent shots included in input video sequence 210 may be separated by a camera cut. Segmentation module 400 may detect a camera cut based on a change in camera viewpoint between consecutive frames in the input video sequence.

In operation 504, video engine 122 identifies one or more scenes included in input video sequence 210 via transition detection module 410. Each of the one or more scenes includes a visual depiction of a particular locale or environment. A scene may include one or more shots, and scenes may be non-contiguous, i.e, the same scene may appear in multiple non-consecutive portions of input video sequence 210. Transition detection module 410 may detect transitions from one scene to another scene based on the presence of common video transition effects such as wipes, fade-ins, and fade-outs. Transition detection module 410 may also detect a transition from one scene to another based on a threshold quantity of pixel-level changes between adjacent frames included in input video sequence 210.

In operation 506, video engine 122 identifies clusters of similar shots and similar scenes included in input video sequence 210 via shot and scene aggregator 420. Shot and scene aggregator 420 may cluster multiple shots captured from identical camera positions. Shot and scene aggregator 420 also clusters shots included in input video sequence 210 into scenes, where multiple shots clustered into a scene each depict the same visual locale or environment.

In operation 508, video engine 122 identifies one or more moving objects included in input video sequence 210. Dynamic content analyzer 430 may identify moving objects included in a particular shot, such as doors, humans, animals, or vehicles. Dynamic content analyzer 430 may determine changes in an object's position between two or more consecutive frames included in the shot. For each frame included in a shot, dynamic content analyzer 430 generates one or more 2D floating-point masks that delineate the frame pixels occupied by the one or more moving objects.

In operation 510, video engine 122 generates, via semantic analyzer 440, one or more semantic features associated with input video sequence 210. Semantic analyzer 440 generates the one or more semantic features via a machine learning model, such as a multimodal large language model (MLLM). For each shot included in input video sequence 210, the machine learning model of semantic analyzer 440 analyzes both the video and audio content included in the shot. Semantic analyzer 440 may generate semantic features that name or describe one or more objects depicted in the shot. Semantic analyzer 440 may also generate semantic features based on the audio content of the shot, such as dialog, music, or sound effects. These audio-based semantic features may provide contextual clues as to the location or mood of the shot, as well as to the actions or dialog included in a shot.

In operation 512, video engine 122 generates video metadata 300 associated with input video sequence 210. Video metadata 300 may include lists of frames that comprise individual shots, as well as lists of shots that depict each of one or more scenes. For each frame included in input video sequence 210, video metadata 300 also includes floating-point masks delineating the boundaries of moving objects included in the frame. Video metadata 300 may further include objects identified in input video sequence 210 as well as semantic features describing the objects or audio content included in input video sequence 210. In various embodiments, video metadata 300 may be stored as a separate sidecar file that is associated with input video sequence 210.

FIG. 6 is a more detailed illustration of environment engine 124 of FIG. 1, according to some embodiments. Environment engine 124 analyzes input video sequence 210 and generates environment metadata 310 based on input video sequence 210, video metadata 300, and the contents of object library 200. Environment engine 124 includes, without limitation, camera parameter estimator 600, depth mapping module 610, planar surface detector 620, orientation estimator 630, object size calibrator 640, material property analyzer 650, lighting analysis module 660, and suitability ranking module 670.

Camera parameter estimator 600 analyzes input video sequence 210 and, for each frame included in input video sequence 210, calculates intrinsic camera parameters. Intrinsic camera parameters may include a focal length of the camera, distortion data associated with the camera, and a principal point associated with the camera. The principal point describes the location on the camera's image plane (e.g., the image sensor in a digital camera) where a line perpendicular to the image plane intersects the image plane after passing through the center of a lens aperture.

Camera parameter estimator 600 may also calculate extrinsic parameters associated with a camera. Extrinsic camera parameters may include the camera's rotation, orientation, or movement during the capture of a video sequence. Based on an analysis of multiple consecutive frames included in input video sequence 210, camera parameter estimator 600 may also generate a time-varying track of the camera's location across the multiple consecutive frames, whether the camera is stationary or in motion.

Depth mapping module 610 calculates, for each frame included in input video sequence 210, relative depth values for each pixel included in the frame. The relative depth values allow environment engine 124 to determine whether a pixel included in the frame is closer to or farther from the camera compared to a different pixel include in the same frame. When calculating relative depth values, depth mapping module 610 may account for camera position or camera motion based on the calculated intrinsic or extrinsic camera parameters. In various embodiments, depth mapping module 610 may generate a visual map associated with the frame, where varying pixel depths are represented by varying colors or brightness values associated with each pixel.

Planar surface detector 620 identifies flat or nearly flat surfaces depicted in one or more frames of input video sequence 210. Based on the relative depth values associated with a frame of input video sequence 210, planar surface detector 620 determines a collection of contiguous pixels included in the frame that lie substantially within the same plane. Planar surface detector 620 may generate a polygon associated with the planar surface that delineates the boundaries of the planar surface. Environment engine 124 may evaluate one or more identified planar surface as potential locations for the insertion of virtual objects into input video sequence 210 as discussed below.

Orientation estimator 630 generates normal vectors for each pixel associated with an identified planar surface. The normal vector associated with a pixel originates at the pixel and is perpendicular to the planar surface at the pixel location. For example, a pixel representing the planar top surface of a desk may have a normal vector that is oriented in an upward direction, while a pixel located on a back wall of a scene may have a normal vector that is oriented toward the camera.

Object size calibrator 640 estimates physical dimensions associated with one or more objects included in a frame of input video sequence 210. Object size calibrator 640 circumscribes an object included in the frame with a 3D bounding box. Based on the pixel dimensions of the bounding box, the relative depth values associated with pixels included within the bounding box, and the estimated intrinsic and extrinsic camera parameters, such as camera focal length and camera position, object size calibrator 640 estimates one or more physical dimensions for the circumscribed object. The estimated physical dimensions may include real-world length units, rather than merely relative or comparative indications of the sizes of different objects.

Material property analyzer 650 generates surface attributes associated with one or more planar surfaces identified in a frame of input video sequence 210. Surface attributes may include measurements of roughness, albedo, or metallic properties of a surface. As discussed below in the description of FIG. 8, placement engine 126 may modify the appearance of a planar surface or an inserted virtual object based on the generated surface attributes.

Lighting analysis module 660 generates, for each of one or more frames included in input video sequence 210, spatially varying 2D and 3D light maps. A 2D light map may include simple luminance values associated with each pixel included in the frame, while a 3D light map may incorporate pixel-wise depth information as determined by depth mapping module 610 discussed above. Based on the 2D and 3D light maps, lighting analysis module 660 may identify both direct and indirect light sources illuminating a scene depicted in the frame.

Suitability ranking module 670 evaluates one or more planar surfaces identified in a shot included in input video sequence 210 for the planar surface's compatibility with one or more virtual objects included in object library 200. Suitability ranking module 670 generates a curated list including optimal placement locations and corresponding virtual objects that harmonize with the shot's ambiance, surfaces, and size constraints.

For each combination of a planar surface and a virtual object, suitability ranking module 670 generates a suitability metric based on the prominence and context of the surface/object pairing. A prominence score measures how long an inserted virtual object will be in view, how large the inserted virtual object will appear in the shot, the extent to which the inserted virtual object would be occluded by one or more different objects, and whether the inserted virtual object will be in focus. A context score measures the extent to which the scene and the placement surface are semantically valid for the virtual object to be inserted.

In some embodiments, suitability ranking module 670 generates the context score via one or more trained machine learning models (not shown), where the one or more machine learning models are trained on object, surface, and scene categories. One machine learning model may generate a scene-object compatibility score that measures the semantic validity of inserting a particular virtual object into a particular scene. For example, a scene-object compatibility score measuring the semantic validity of inserting a coffee maker into a scene depicting an office environment may be higher than a scene-object compatibility score measuring the semantic validity of inserting the same coffee maker into a scene depicting the interior of a vehicle. The same machine learning model or a different machine learning model may generate a surface-object compatibility score measuring the semantic validity of placing a particular virtual object on a particular planar surface included in a scene. For example, a surface-object compatibility score measuring the semantic validity of placing a poster on a wall may be higher than a surface-object compatibility score for the same poster when placed on a desktop.

$$\text{?} \qquad ( 1 )$$

$$\text{?} \qquad ( 2 )$$

$$\text{?} \qquad ( 3 )$$

$$\text{?} \text{indicates text missing or illegible when filed}$$

In Equation (2) above, the framewise summation of the virtual object's pixel count is influenced by the duration of the object's appearance across multiple frames, the size of the object within the multiple frames, and whether or not the virtual object is partially or fully occluded during one or more frames. Longer object placements, larger objects, and minimal occlusion will increase the framewise object pixel count summation and the prominence score. The framewise blurriness summation represents the extent to which the virtual object will be in focus during multiple frames. Suitability ranking module 670 may estimate per-frame blurriness for a virtual object based on environment metadata 310 associated with a frame, including intrinsic and extrinsic camera parameters and a depth map associated with the frame. A lower blurriness value associated with a frame indicates that the virtual object will be out of focus to some extent and will reduce both the framewise blurriness summation and the prominence score.

The suitability metric penalizes both long object placements that break scene context (e.g., a shampoo bottle on an office desk) as well as short-duration object placements, even if the placement is in context for the scene and/or surface. In various embodiments, each term included in Equations (1), (2), or (3) may include an adjustable multiplicative scaling factor to modify the contributions of the individual terms to the suitability metric. For each frame included in input video sequence 210, suitability ranking module 670 may evaluate a suitability metric for one or more combinations of a planar surface identified in the scene and a virtual object included in object library 200. Suitability ranking module 670 may order the evaluated combinations by their suitability metric values and record the evaluated combinations and suitability metric values in environment metadata 310.

Environment engine 124 may transmit the values generated by the various components included in environment engine 124 to environment metadata 310. Environment metadata 310 may include metadata associated with each frame of input video sequence 210. The metadata may include intrinsic and extrinsic camera values, pixel depth maps, identified planar surfaces and polygonal boundaries defining the planar surfaces, and orientation vectors for each pixel included in a planar surface. The metadata may further include estimated object sizes for each object included in the frame, material properties associated with each planar surface, 2D and 3D light maps associated with the frame, and suitability metric scores associated with one or more virtual object-surface pairings.

The operations of environment engine 124 are non-destructive and do not require any modifications to input video sequence 210. In various embodiments, environment metadata 310 may be stored as a separate sidecar file that is associated with input video sequence 210.

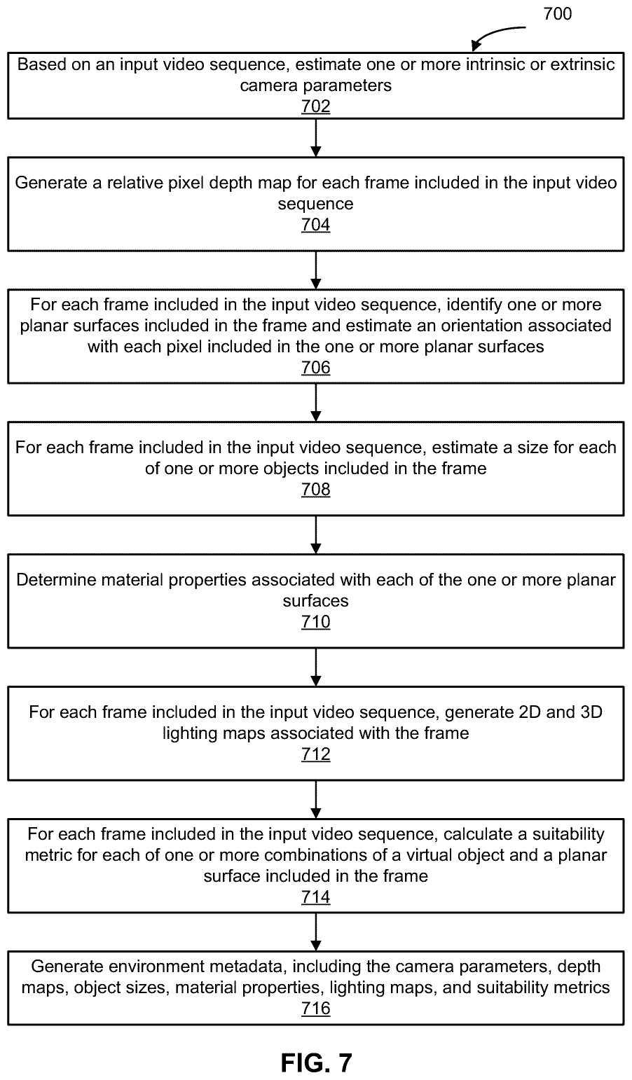

FIG. 7 is a flow diagram of method steps for generating environment metadata, according to some embodiments. Although the method steps are described in conjunction with the systems of FIGS. 1, 4, and 6, persons skilled in the art will understand that any system configured to perform the method steps in any order falls within the scope of the present disclosure.

As shown, in operation 702 of method 700, environment engine 124 estimates, via camera parameter estimator 600, one or more intrinsic and/or extrinsic camera parameters associated with a camera used to capture input video sequence 210. Intrinsic camera parameters may include a focal length of the camera, distortion data associated with the camera, and a principal point associated with the camera. Camera parameter estimator 600 may also calculate extrinsic parameters associated with a camera. Extrinsic camera parameters may include the camera's rotation, orientation, or movement during the capture of a video sequence. Based on an analysis of multiple consecutive frames included in input video sequence 210, camera parameter estimator 600 may also generate a time-varying track of the camera's location across the multiple consecutive frames, whether the camera is stationary or in motion.

In operation 704, environment engine 124 generates a relative pixel depth map for each frame included in input video sequence 210. Depth mapping module 610 calculates, for each frame included in input video sequence 210, relative depth values for each pixel included in the frame. The relative depth values allow environment engine 124 to determine whether a pixel included in the frame is closer to or farther from the camera compared to a different pixel include in the same frame. When calculating relative depth values, depth mapping module 610 may account for camera position or camera motion based on the calculated intrinsic or extrinsic camera parameters. In various embodiments, depth mapping module 610 may generate a visual map associated with the frame, where varying pixel depths are represented by varying colors or brightness values associated with each pixel.

In operation 706, environment engine 124 identifies one or more planar surfaces in each frame of input video sequence 210 and estimates an orientation associated with each pixel included in each of the one or more planar surfaces. Planar surface detector 620 identifies flat or nearly flat surfaces depicted in one or more frames of input video sequence 210. Based on the relative depth values associated with a frame of input video sequence 210, planar surface detector 620 determines a collection of contiguous pixels included in the frame that lie substantially within the same plane. Planar surface detector 620 may generate a polygon associated with the planar surface that delineates the boundaries of the planar surface. Orientation estimator 630 generates normal vectors for each pixel associated with an identified planar surface. The normal vector associated with a pixel originates at the pixel and is perpendicular to the planar surface at the pixel location.

In operation 708, environment engine 124 identifies one or more objects included in each frame of input video sequence 210. Object size calibrator 640 estimates physical dimensions associated with one or more objects included in a frame of input video sequence 210. Object size calibrator 640 circumscribes an object included in the frame with a 3D bounding box. Based on the pixel dimensions of the bounding box, the relative depth values associated with pixels included within the bounding box, and the estimated intrinsic and extrinsic camera parameters, such as camera focal length and camera position, object size calibrator 640 estimates one or more physical dimensions for the circumscribed object. The estimated physical dimensions may include real-world length units, rather than merely relative or comparative indications of the sizes of different objects.

In operation 710, environment engine 124 determines material properties associated with each of the one or more planar surfaces. Material property analyzer 650 generates surface attributes associated with one or more planar surfaces identified in a frame of input video sequence 210. Surface attributes may include measurements of roughness, albedo, or metallic properties of a surface.

In operation 712, environment engine 124 generates 2D and 3D lighting maps associated with each frame included in input video sequence 210. Lighting analysis module 660 generates, for each of one or more frames included in input video sequence 210, spatially varying 2D and 3D light maps. A 2D light map may include simple luminance values associated with each pixel included in the frame, while a 3D light map may incorporate pixel-wise depth information to calculate the location and orientation of one or more light sources. Based on the 2D and 3D light maps, lighting analysis module 660 may identify both direct and indirect light sources illuminating a scene depicted in the frame.

In operation 714, environment engine calculates, for each scene included in input video sequence 210, one or more suitability metrics, where each suitability metric is based on a combination of a virtual object included in object library 200 and a planar surface identified in the scene. Suitability ranking module 670 evaluates one or more planar surfaces identified in a scene included in input video sequence 210 for the planar surface's compatibility with one or more virtual objects included in object library 200. Suitability ranking module 670 generates a curated list including optimal placement locations and corresponding virtual objects that harmonize with the scene's ambiance, surfaces, and size constraints.

For each combination of a planar surface and a virtual object, suitability ranking module 670 generates the suitability metric based on the prominence and context of the surface/object pairing. A prominence score measures how long an inserted virtual object will be in view, how large the inserted virtual object will appear in the scene, the extent to which the inserted virtual object would be occluded by one or more different objects, and whether the inserted virtual object will be in focus. A context score measures the extent to which the scene and the placement surface are semantically valid for the virtual object to be inserted.

In some embodiments, suitability ranking module 670 generates the context score via one or more trained machine learning models, where the one or more machine learning models are trained on object, surface, and scene categories. One machine learning model may generate a scene-object compatibility score that measures the semantic validity of inserting a particular virtual object into a particular scene. The same machine learning model or a different machine learning model may generate a surface-object compatibility score measuring the semantic validity of placing a particular virtual object on a particular planar surface included in a scene.

For each of one or more scenes included in input video sequence 210, suitability ranking module 670 may evaluate a suitability metric for one or more combinations of a planar surface identified in the scene and a virtual object included in object library 200. Suitability ranking module 670 may order the evaluated combinations by their suitability metric values and record the evaluated combinations and suitability metric values in environment metadata 310.

In operation 716, environment engine 124 generates environment metadata 310. Environment metadata 310 may include metadata associated with each frame of input video sequence 210. The metadata may include intrinsic and extrinsic camera values, pixel depth maps, identified planar surfaces and polygonal boundaries defining the planar surfaces, and orientation vectors for each pixel included in a planar surface. The metadata may further include estimated object sizes for each object included in the frame, material properties associated with each planar surface, 2D and 3D light maps associated with the frame, and suitability metric scores associated with one or more virtual object-surface pairings.

FIG. 8 is a more detailed illustration of placement engine 126 of FIG. 1, according to some embodiments. Placement engine 126 allows a user to select one or more virtual objects included in object library 200 for placement into input video sequence 210 and generates modified video sequence 220 that includes all or a portion of input video sequence 210 as augmented with the one or more inserted objects. Placement engine 126 includes multiple machine learning models to generate realistic virtual object placements and automatically adjust user inputs included in generator control display 810 and placement control display 820 to improve both the realism and placement of the inserted virtual objects. The operation of placement engine 126 is further guided by video metadata 300 and environment metadata 310. Placement engine 126 includes, without limitation, generator 830, composited video 840, generation discriminator 850, generation loss function 860, placement discriminator 870, and placement loss function 880.

Generator control display 810 includes an interactive display having multiple virtual knobs, where each virtual knob establishes a spectrum of potential values for a user-controllable input parameter to generator 830 described below. Additionally, generator control display 810 includes appearance controls that enable a user to adjust an inserted virtual object's size, orientation, lighting conditions, shadowing, blurring, and reflective properties.

Placement control display 820 includes an interactive display enabling a user to select a virtual object included in object library 200 for insertion into input video sequence 210. Placement control display 820 also allows the user to specify an insertion position for the virtual object within a scene included in input video sequence 210. As discussed above, environment metadata 310 includes, for each frame of input video sequence 210, a list of potential object/surface pairings, with an associated suitability metric for each potential pairing. Placement engine 126 may present the list of potential pairings and associated suitability metrics to a user via placement control display 820. The user may also specify a duration associated with the inserted virtual object based on the number of frames into which the virtual object is to be inserted. In various embodiments, the user may, based on video metadata 300, specify one or more individual frames, all frames associated with a particular shot, or all frames associated with a particular scene.

At inference time, generator 830 executes a frame-by-frame analysis of input video sequence 210 and a user-selected virtual object included in object library 200 and generates composited video 840, where composited video 840 includes one or more frames of input video sequence 210 augmented with the user-selected virtual object. Placement engine 126 may condition generator 830 on one or both of video metadata 300 and environment metadata 310, as well as one or more user-controlled input parameters received from generator control display 810 discussed above.

In various embodiments, generator 830 may include multiple trained machine learning models, such as a differentiable rendering generator and a differentiable diffusion generator. Prior to inference time, each of the multiple machine learning models is optimized via a training discriminator (not shown). The training discriminator is previously configured to differentiate between authentic (i.e. unaltered) video frames and video frames that have been augmented with virtual objects. The training discriminator iteratively modifies one or more parameters of the rendering generator and diffusion generator via backpropagation based on an adversarial loss function. At the conclusion of the optimization, the machine learning models included in generator 830 may produce augmented video frames that the training discriminator is unable to differentiate from authentic video frames.

Generation discriminator 850 performs a frame-by frame analysis of composited video 840 generated by generator 830 and enables placement engine 126 to perform automatic adjustments to one or more virtual knobs included in generator control display 810. Similar to the training discriminator discussed above, generation discriminator 850 is configured to differentiate between authentic video frames and video frames that have been augmented with inserted virtual objects. For each analyzed frame included in composited video 840, generation discriminator 850 generates a generation loss function 860.

Generation loss function 860 includes errors representing the inauthentic appearance of one or more virtual objects inserted into a frame of input video sequence 210. Placement engine 126 back-propagates the errors through the one or more machine learning models included in generator 830 and iteratively optimizes one or more input parameters associated with the one or more machine learning models, while holding the internal weights of the one or more machine learning models static. Placement engine 126 transmits the optimized machine learning model input parameters to generator control display 810 and updates the values of the associated virtual knobs included in generator control display 810. After input parameter optimization, a user may make additional modifications to one or more input parameters via generator control display 810, and placement engine 126 may direct generator 830 to produce an updated composited video 840 based on the optimized and/or user-modified input parameters. Placement engine 126 transmits updated composited video 840 to placement discriminator 870.

Placement discriminator 870 analyzes updated composited video 840 and generates placement loss function 880. Placement engine 126 automatically optimizes one or more virtual knob values included in placement control display 820 based on placement loss function 880. Based on the optimized virtual knob values, placement engine 126 may generate modified video sequence 220.

Placement discriminator 870 is configured to differentiate between two classes of video sequences. One class of video sequences includes previously augmented video sequences crafted by the current user. The second class of video sequences includes unaugmented video sequences and previously augmented video sequences crafted by a user other than the current user. Prior to inference time, placement discriminator 870 may be optimized based on an identity of the current user and a training database (not shown) that includes multiple labeled training samples.

Based on the analysis of composited video 840, placement discriminator 870 generates placement loss function 880. Placement loss function 880 includes adversarial loss errors that describe a degree of dissimilarity between virtual object placement in composited video 840 and virtual object placement in historical videos that were crafted by the current user and included in the training database.

Placement engine 126 back-propagates the errors included in placement loss function 880 through the one or more machine learning models included in generator 830 and iteratively optimizes one or more placement parameters included in placement control display 820. While optimizing the one or more placement parameters, placement engine 126 holds the internal weights of the one or more machine learning models static. After parameter optimization, the user may make further adjustments to the virtual knobs included in placement control display 820.

After optimizing the generator and/or placement parameters, placement engine 126 may generate modified video sequence 220 via generator 830, based on the optimized parameters and any further user modifications. Modified video sequence 220 includes all or a portion of input video sequence 210, augmented by the insertion of one or more virtual objects. Placement engine 126 may store modified video sequence 220 in, e.g., storage 114. Additionally or alternatively, placement engine may present modified video sequence 220 to a user via one or more of I/O devices 108 or transmit modified video sequence 220 to a downstream software application for further processing.

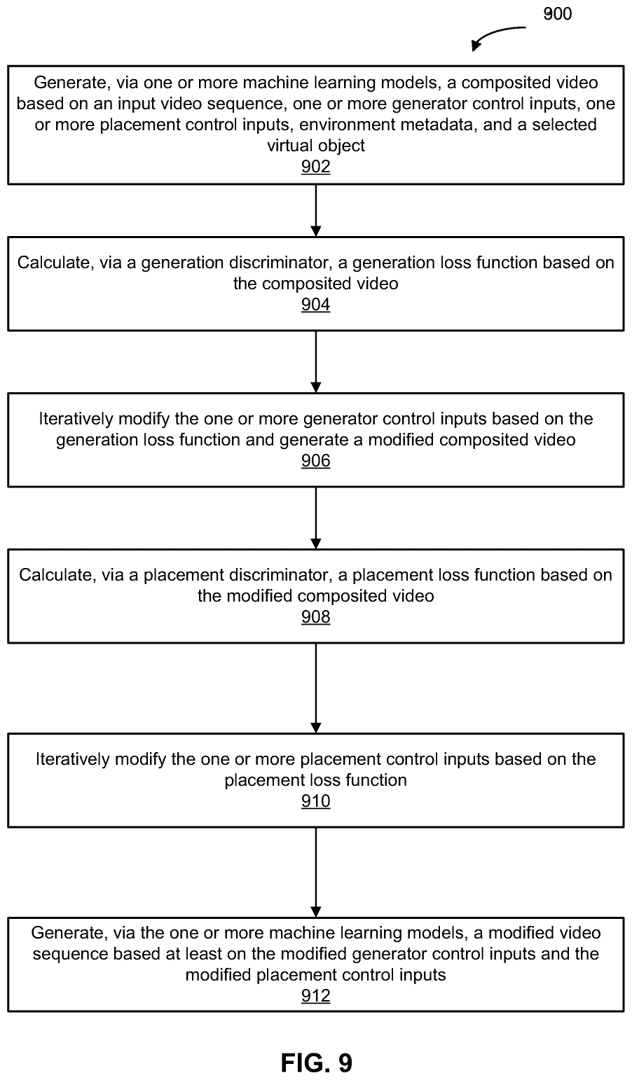

FIG. 9 is a flow diagram of method steps for placing one or more virtual objects in a scene, according to some embodiments. Although the method steps are described in conjunction with the systems of FIGS. 1, 4, 6, and 8, persons skilled in the art will understand that any system configured to perform the method steps in any order falls within the scope of the present disclosure.

As shown, in operation 902 of method 900, placement engine 126 generates, via generator 830, a composited video based on input video sequence 210 and a virtual object included in object library 200. Generator 830 takes as input one or more generator control values included in generator control display 810 and one or more placement control values included in placement control display 820. Generator 830 is further conditioned on environment metadata 310. Generator 830 may include one or more trained machine learning models, such as a differentiable rendering generator or a differentiable diffusion generator. Generator 830 produces composited video 840, where composited video 840 includes all or a portion of input video sequence 210 as augmented with the insertion of a user-selected virtual object included in object library 200.

In operation 904, placement engine 126 generates, via generation discriminator 850, a generation loss function 860. Generation discriminator 850 includes a trained machine learning model configured to differentiate between authentic images, i.e., unmodified images that do not include inserted virtual objects, and modified images that include one or more inserted virtual objects. Generation loss function 860 includes errors representing the inauthentic appearance of one or more virtual objects inserted into a frame of input video sequence 210.

In operation 906, placement engine 126 back-propagates the errors included in generation loss function 860 through the one or more machine learning models included in generator 830 and iteratively optimizes one or more input parameters associated with the one or more machine learning models, while holding the internal weights of the one or more machine learning models static. Placement engine 126 transmits the optimized machine learning model input parameters to generator control display 810 and updates the values of the associated virtual knobs included in generator control display 810. After input parameter optimization, a user may make additional modifications to one or more input parameters via generator control display 810, and placement engine 126 may direct generator 830 to produce an updated composited video 840 based on the optimized and/or user-modified input parameters. Placement engine 126 transmits updated composited video 840 to placement discriminator 870.

In operation 908, placement discriminator 870 generates placement loss function 880 based on updated composited video 840. Placement discriminator 870 is configured to differentiate between two classes of video sequences. One class of video sequences includes previously augmented video sequences crafted by the current user. The second class of video sequences includes unaugmented video sequences and previously augmented video sequences crafted by a user other than the current user. Placement loss function 880 includes adversarial loss errors that describe a degree of dissimilarity between virtual object placement in updated composited video 840 and virtual object placement in historical videos that were crafted by the current user.

In operation 910, placement engine 126 back-propagates the errors included in placement loss function 880 through the one or more machine learning models included in generator 830 and iteratively optimizes one or more placement parameters included in placement control display 820. While optimizing the one or more placement parameters, placement engine 126 holds the internal weights of the one or more machine learning models static. After parameter optimization, the user may make further manual adjustments to the virtual knobs included in placement control display 820.

In operation 912, placement engine 126 may generate modified video sequence 220 via generator 830, based on the optimized control and placement parameters and any manual user adjustments. Modified video sequence 220 includes all or a portion of input video sequence 210, augmented by the insertion of one or more virtual objects. Placement engine 126 may store modified video sequence 220 in, eg, storage 114. Additionally or alternatively, placement engine may present modified video sequence 220 to a user via one or more of I/O devices 108 or transmit modified video sequence 220 to a downstream software application for further processing.

In sum, the disclosed techniques provide an automated, client-side, end-to-end virtual object placement capability for the adaptive insertion of virtual objects within a video sequence. The disclosed techniques analyze a video sequence, identify transitions included in the video sequence, and cluster similar portions of the video sequence based on camera angles and/or the content of the video sequence. The disclosed techniques also detect moving objects included in the video sequence and perform semantic analysis of audiovisual content included in the video sequence.

The disclosed techniques further analyze one or more environments depicted in the video sequence and perform camera parameter estimation, depth mapping, surface analysis, material property analysis, and lighting analysis based on the one or more environments. The disclosed techniques determine the suitability of one or more virtual objects included in an object library for placement within the video sequence.

The disclosed techniques also provide an interactive client-side interface allowing a user to specify the type, location, and timing of virtual objects to be inserted into the video sequence. Via various machine learning models, the disclosed techniques may automatically modify one or more user settings to place virtual objects that are not only realistic in appearance, but also align with the current user's preferences, inferred from past user interactions with historical video sequences.

In operation, a video engine analyzes an input video sequence and segments the video sequence into shots based on camera cuts. A shot is a sequential series of consecutive frames captured from a single fixed or moving camera viewpoint. Adjacent shots may be separated by a camera cut. The video engine may detect a camera cut based on a change in camera viewpoint between consecutive frames in the input video sequence. The video engine also divides the video sequence into scenes, where a scene includes one or more shots portraying the same visual environment, or locale. Scenes may be non-contiguous, i.e., the same scene may appear in multiple non-consecutive portions of the video sequence. The video engine segments the video sequence into scenes by detecting transitions between scenes. A scene transition may include a common visual effect, such as a wipe or a fade from one scene to another. The video engine may also detect a scene transition as a change in a threshold number of pixels between consecutive frames of the video sequence. The video engine may identify clusters of similar shots and clusters of similar scenes.

The video engine also identifies dynamic content included in the video sequence. The video engine identifies and segments moving entities, such as doors, humans, animals, or vehicles at the pixel level within each frame of the video sequence. For each frame that includes one or more moving entities, the video engine generates a two-dimensional (2D) mask associated with each moving entity that describes the pixels in the frame that are occupied by the entity.

The video engine further performs semantic analysis of each identified scene's visual and auditory content and generates contextual semantic data associated with the scene. The contextual semantic data informs the disclosed techniques' object suitability assessment described below. For example, the disclosed techniques are less likely to recommend the insertion of a shampoo bottle into a scene representing an office environment as compared to a residential bathroom environment.

The results of the video engine's various analyses of the input video sequence may be recorded as video metadata associated with the input video sequence. The disclosed techniques do not require editing or other modifications to the original input video sequence by the video engine.

An environment engine analyzes one or more frames included in the input video sequence that are associated with a particular shot. For each frame associated with the shot, the environment engine determines intrinsic and extrinsic camera parameters associated with the shot. Intrinsic camera parameters may include a focal length associated with the camera, distortion data associated with the camera, or a principal point associated with the camera. Extrinsic camera parameters may include the camera's rotation, orientation, or movement during the video capture of the shot. The environment engine also calculates a comprehensive track of the camera's position during the shot, whether the camera is stationary or in motion.

For each frame of the input video sequence, the environment engine estimates a relative depth value for each pixel included in the frame. The relative depth values indicate whether a pixel is closer to or farther away from the camera compared to a different pixel. Based on the relative depth values, the disclosed techniques may determine whether an object to be inserted into a scene will be occluded (blocked) by one or more different objects.

The environment engine may perform surface analysis on a scene. For a frame included in the scene, the environment engine identifies all planar surfaces included in the frame and, for each planar surface, generates a polygon encompassing the planar surface. For each pixel included in a planar surface, the environment engine calculates a normal vector that describes the orientation of the pixel. For example, the environment engine may determine that each pixel included in the horizontal surface of a desk may face in an upwards direction, or that each pixel included in a wall may face the camera. The environment engine may also account for camera orientation when determining normal vectors for pixels included in a planar surface.

The environment engine may also calculate sizes for one or more objects included in a scene, and determine various material properties for the one or more objects, including roughness, albedo, and metallic or reflective properties. The environment engine may further produce 2D spatially varying light maps and three-dimensional (3D) light maps that incorporate depth information for a scene.

The environment engine may further generate one or more suitability rankings, where each suitability ranking is associated with a combination of a virtual object included in an object library and a planar surface included in a scene. The suitability ranking for a particular object/surface combination is based on the prominence and context of the combination. The prominence of a particular object/surface combination is based on, e.g., the relative size of the virtual object within the scene, whether the virtual object will be occluded by other objects, how long the virtual object will appear in the scene, and whether or not the virtual object will be in focus. The context of a particular object/surface combination is based on an evaluation of the semantic relationships between the virtual object, the surface, and the scene. The suitability ranking may penalize potential object/surface combinations that are out of context for the virtual object, surface, or scene, as well as short-duration virtual object placements, even if they may appear in a proper context.

The environment engine may store all analysis results and/or suitability rankings as environment metadata associated with the input video sequence. Similar to the video engine, the operation of the environment engine does not require editing or other modifications to the original input video sequence.

A placement engine provides an interactive client-side interface allowing a user to adjust the placement and appearance of one or more virtual objects to be included in the input video sequence. The placement engine enables the user to select the position and timing of the virtual objects within a scene. The user may also adjust the virtual object's size, orientation, lighting conditions, shadowing, blurring, and reflective properties. As the user modifies a virtual object, the disclosed techniques will adapt the virtual object's appearance based on, e.g., light information associated with the scene.

The placement engine includes one or more differentiable machine learning models, such as rendering generators and/or diffusion generators. Each controllable parameter associated with the machine learning models is governed by a user-defined virtual knob and conditioned on the environment metadata generated by the environment engine. Each virtual knob establishes a range of potential values for a controllable parameter included in the one or more machine learning models. The one or more machine learning models produce augmented video frames based on user selections associated with one or more virtual objects and the controllable machine learning model parameters. The augmented video frames include frames from the input video sequence augmented with one or more inserted virtual objects.

The placement engine may also include a discriminator machine learning model that has been trained to distinguish between authentic video frames and video frames augmented with one or more virtual objects. The discriminator analyzes an augmented video frame and either correctly determines that the video frame has been augmented or incorrectly determines that the augmented video frame is unmodified. Based on the discriminator's determinations, the placement engine iteratively modifies one or more parameters of the one or more differentiable machine learning models to produce realistic video frames including one or more inserted virtual objects.

At inference time, the placement engine generates an adversarial loss based on augmented video frames generated by the one or more differentiable machine learning models. Based on the adversarial loss, the placement engine modifies one or more virtual knob settings, ensuring the generation of realistic images. The virtual knobs are presented to the user via the interactive interface, where the user may make further adjustments to the virtual knob settings.

The placement engine may include an additional adversarial loss function from a discriminator that has been trained to differentiate between videos crafted by a specific user and videos generated by a random user or videos that have not been virtually augmented. Based on the additional adversarial loss, the placement engine may adjust the placement or appearance of one or more virtual objects, ensuring alignment with the current user's preferences, inferred from the user's past interactions and/or placements in historical videos. The placement engine generates a modified video sequence that includes the input video sequence and one or more inserted virtual objects.

One technical advantage of the disclosed techniques relative to the prior art is that the disclosed techniques provide an automated, end-to-end approach to virtual object placement. The disclosed techniques automatically identify placement locations for a virtual object in a destination scene, where the placement locations are both physically suitable for the virtual object and contextually appropriate based on the semantic attributes of the scene. The disclosed techniques may also automatically adjust the appearance of the virtual object to match the environmental conditions of the destination scene. The disclosed techniques further provide both automatic and manual adjustment of user settings during virtual object placement, providing immediate feedback to the user and obviating the need for repetitive manual adjustment and evaluation. These technical advantages provide one or more improvements over prior art approaches.

1. In some embodiments, a computer-implemented method for performing virtual object placement in a video sequence, the computer-implemented method comprises identifying a planar surface depicted in an input video sequence, selecting a virtual object included in an object library, generating, for a combination of the planar surface and the virtual object, a suitability metric associated with the combination, wherein the suitability metric is based at least on a semantic compatibility between the virtual object and the planar surface, and generating, via one or more machine learning models, a modified video sequence based on the suitability metric, wherein the modified video sequence depicts the virtual object placed on the planar surface.

2. The computer-implemented method of clause 1, wherein the suitability metric is further based on a semantic compatibility between the virtual object and a scene depicted in the input video sequence.

3. The computer-implemented method of clauses 1 or 2, wherein the suitability metric is further based on a size or a duration associated with the virtual object.

4. The computer-implemented method of any of clauses 1-3, wherein the one or more machine learning models include a rendering generator or a diffusion generator.

5. The computer-implemented method of any of clauses 1-4, further comprising iteratively modifying one or more input parameters associated with the one or more machine learning models based on a generation loss function.

6. The computer-implemented method of any of clauses 1-5, further comprising iteratively modifying one or more placement parameters based on a placement loss function.

7. The computer-implemented method of any of clauses 1-6, further comprising generating a polygon defining a boundary of the planar surface.

8. The computer-implemented method of any of clauses 1-7, further comprising generating, for each of one or more pixels included in the planar surface, a normal vector describing an orientation of the pixel.

9. The computer-implemented method of any of clauses 1-8, further comprising generating a relative pixel depth map associated with a frame included in the input video sequence.

10. The computer-implemented method of any of clauses 1-9, further comprising generating an ordered list of combinations of virtual objects and planar surfaces based at least on the suitability metric.

11. In some embodiments, one or more non-transitory computer-readable media store instructions that, when executed by one or more processors, cause the one or more processors to perform the steps of identifying a planar surface depicted in an input video sequence, selecting a virtual object included in an object library, generating, for a combination of the planar surface and the virtual object, a suitability metric associated with the combination, wherein the suitability metric is based at least on a semantic compatibility between the virtual object and the planar surface, and generating, via one or more machine learning models, a modified video sequence based on the suitability metric, wherein the modified video sequence depicts the virtual object placed on the planar surface.

12. The one or more non-transitory computer-readable media of clause 11, wherein the suitability metric is further based on a semantic compatibility between the virtual object and a scene depicted in the input video sequence.

13. The one or more non-transitory computer-readable media of clauses 11 or 12, wherein the suitability metric is further based on a size or a duration associated with the virtual object.

14. The one or more non-transitory computer-readable media of any of clauses 11-13, wherein the one or more machine learning models include a rendering generator or a diffusion generator.

15. The one or more non-transitory computer-readable media of any of clauses 11-14, wherein the instructions further cause the one or more processors to perform the step of iteratively modifying one or more input parameters associated with the one or more machine learning models based on a generation loss function.

16. The one or more non-transitory computer-readable media of any of clauses 11-15, wherein the instructions further cause the one or more processors to perform the step of iteratively modifying one or more placement parameters based on a placement loss function.

17. The one or more non-transitory computer-readable media of any of clauses 11-16, wherein the instructions further cause the one or more processors to perform the step of generating a polygon defining a boundary of the planar surface.

18. The one or more non-transitory computer-readable media of any of clauses 11-17, wherein the instructions further cause the one or more processors to perform the step of generating, for each of one or more pixels included in the planar surface, a normal vector describing an orientation of the pixel.

19. In some embodiments, a system comprises one or more memories storing instructions, and one or more processors for executing the instructions to identify a planar surface depicted in an input video sequence, select a virtual object included in an object library, generate, for a combination of the planar surface and the virtual object, a suitability metric associated with the combination, wherein the suitability metric is based at least on a semantic compatibility between the virtual object and the planar surface, and generate, via one or more machine learning models, a modified video sequence based on the suitability metric, wherein the modified video sequence depicts the virtual object placed on the planar surface.

20. The system of clause 19, wherein the suitability metric is further based on a semantic compatibility between the virtual object and a scene depicted in the input video sequence.

Any and all combinations of any of the claim elements recited in any of the claims and/or any elements described in this application, in any fashion, fall within the contemplated scope of the present invention and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing virtual object placement in a video sequence, the computer-implemented method comprising:
identifying a planar surface depicted in an input video sequence;
selecting a virtual object included in an object library;
generating, for a combination of the planar surface and the virtual object, a suitability metric associated with the combination, wherein the suitability metric is based at least on a semantic compatibility between the virtual object and the planar surface; and
generating, via one or more machine learning models, a modified video sequence based on the suitability metric, wherein the modified video sequence depicts the virtual object placed on the planar surface.

2. The computer-implemented method of claim 1, wherein the suitability metric is further based on a semantic compatibility between the virtual object and a scene depicted in the input video sequence.

3. The computer-implemented method of claim 2, wherein the suitability metric is further based on a size or a duration associated with the virtual object.

4. The computer-implemented method of claim 1, wherein the one or more machine learning models include a rendering generator or a diffusion generator.

5. The computer-implemented method of claim 1, further comprising iteratively modifying one or more input parameters associated with the one or more machine learning models based on a generation loss function.

6. The computer-implemented method of claim 1, further comprising iteratively modifying one or more placement parameters based on a placement loss function.

7. The computer-implemented method of claim 1, further comprising generating a polygon defining a boundary of the planar surface.

8. The computer-implemented method of claim 1, further comprising generating, for each of one or more pixels included in the planar surface, a normal vector describing an orientation of the pixel.

9. The computer-implemented method of claim 1, further comprising generating a relative pixel depth map associated with a frame included in the input video sequence.

10. The computer-implemented method of claim 1, further comprising generating an ordered list of combinations of virtual objects and planar surfaces based at least on the suitability metric.

11. One or more non-transitory computer-readable media storing instructions that, when executed by one or more processors, cause the one or more processors to perform the steps of:
identifying a planar surface depicted in an input video sequence;
selecting a virtual object included in an object library;
generating, for a combination of the planar surface and the virtual object, a suitability metric associated with the combination, wherein the suitability metric is based at least on a semantic compatibility between the virtual object and the planar surface; and
generating, via one or more machine learning models, a modified video sequence based on the suitability metric, wherein the modified video sequence depicts the virtual object placed on the planar surface.

12. The one or more non-transitory computer-readable media of claim 11, wherein the suitability metric is further based on a semantic compatibility between the virtual object and a scene depicted in the input video sequence.

13. The one or more non-transitory computer-readable media of claim 12, wherein the suitability metric is further based on a size or a duration associated with the virtual object.

14. The one or more non-transitory computer-readable media of claim 11, wherein the one or more machine learning models include a rendering generator or a diffusion generator.

15. The one or more non-transitory computer-readable media of claim 11, wherein the instructions further cause the one or more processors to perform the step of iteratively modifying one or more input parameters associated with the one or more machine learning models based on a generation loss function.

16. The one or more non-transitory computer-readable media of claim 11, wherein the instructions further cause the one or more processors to perform the step of iteratively modifying one or more placement parameters based on a placement loss function.

17. The one or more non-transitory computer-readable media of claim 11, wherein the instructions further cause the one or more processors to perform the step of generating a polygon defining a boundary of the planar surface.

18. The one or more non-transitory computer-readable media of claim 11, wherein the instructions further cause the one or more processors to perform the step of generating, for each of one or more pixels included in the planar surface, a normal vector describing an orientation of the pixel.

19. A system comprising:
one or more memories storing instructions; and
one or more processors for executing the instructions to:
identify a planar surface depicted in an input video sequence;
select a virtual object included in an object library;
generate, for a combination of the planar surface and the virtual object, a suitability metric associated with the combination, wherein the suitability metric is based at least on a semantic compatibility between the virtual object and the planar surface; and
generate, via one or more machine learning models, a modified video sequence based on the suitability metric, wherein the modified video sequence depicts the virtual object placed on the planar surface.

20. The system of claim 19, wherein the suitability metric is further based on a semantic compatibility between the virtual object and a scene depicted in the input video sequence.
